(19) United States
(12) Patent Application Publication
(10) Pub. No.: US 2019/0063009 A1
(43) Pub. Date: Feb. 28, 2019

(54) TELESCOPING MARKING DEVICE

(71) Applicant: Michael Mongelluzzo, East Quogue, NY (US)

(72) Inventor: Michael Mongelluzzo, East Quogue, NY (US)

(21) Appl. No.: 15/872,721

(22) Filed: Jan. 16, 2018

Related U.S. Application Data
(60) Provisional application No. 62/550,821, filed on Aug. 28, 2017.

(51) Int. Cl. E01C 23/02; E01C 23/09; E01C 23/04

(52) U.S. Cl. CPC E01C 23/02; B25H 7/04; E01C 23/04; E01C 23/0986

(57) ABSTRACT

A marking device that includes a base; at least two telescoping legs movably coupled to the base; and an indicator, the indication being attached to a top portion of an uppermost leg of the at least two telescoping legs, the marking device including: (1) a retracted position wherein the at least two telescoping legs are seated within the base and (2) an extended position wherein the at least two telescoping legs are telescoped outwards from the base and locked in the extended position.

### CROSS REFERENCE TO RELATED APPLICATIONS

This application claims priority to U.S. Prov. Pat. App. No. 62/550,821 filed Aug. 28, 2017, hereby incorporated by reference in its entirety.

### BACKGROUND

Reflective roadway markers currently being sold in the marketplace are used to mark and delineate driveways, entrances, pathways, roads, and trails. These markers can also protect curbs and grass from being run over by vehicular traffic at night particularly where the curb or grass meets the street.

Driveway markers can also be used during snow season. That is, these markers can be tall enough to line your property adjacent to driveways, pathways and streets so that they are visible above the snow line. It helps with shoveling and plowing as well as directing plow trucks to stay within the street and not disrupt your lawn, curbs or mailboxes.

To set these roadway markers in place, a pointed end of the marker can be pushed into the ground to a depth that allows the marker to stand on its own. These driveway markers can be pulled out and stored in the summer months or they can be left in place during the summer and removed, as needed, for lawn maintenance, e.g., mowing.

The disadvantage of these markers is that they easily fall over, cannot be set in frozen ground and are obstacles when performing routine lawn maintenance. Also, in order for them to be seen at night, a light source must be reflected off the reflective surface.

### SUMMARY

The disclosed technology is related to a marking device that can be permanently installed in the ground adjacent driveways, entrances, pathways, roads, and trails and moved from a retracted position to telescoped position based on needs of the user.

In one implementation, a marking device can comprise: a base; at least two telescoping legs movably coupled to the base; and an indicator, the indication being attached to a top portion of an uppermost leg of the at least two telescoping legs, the marking device including: (1) a retracted position wherein the at least two telescoping legs are seated within the base and (2) an extended position wherein the at least two telescoping legs are telescoped outwards from the base and locked in the extended position.

In some implementations, the base can include a ribbed outer layer, the ribbed outer layer capable of being seated beneath a ground surface. In some implementations, the base can include a drain hole and elevation steps. In some implementations, the elevation steps can allow the at least two telescoping legs to sit above the drain hole when in the retracted position.

In some implementations, the at least two telescoping legs can include a first section, a second section and a third section. In some implementations, the first section, the second section and the third section can include locking mechanisms for locking the first section, the second section and the third section in the extended position.

In some implementations, the marking device can further comprise: a cap, the cap covering a top portion of the marking device so that water is inhibited from entering an interior of the marking device. In some implementations, the cap includes an opening for receiving the marking indicator.

In some implementations, the marking indicator can be a flag. In some implementations, the marking indicator can be a lighting fixture. In some implementations, the lighting fixture can include a spike for attaching to the cap via the opening. In some implementations, the lighting fixture can include a solar panel electrically coupled to at least one LED bulb. In some implementations, the lighting fixture can include a shroud. In some implementations, the lighting fixture can include a switch electrically coupled to a bulb held within the lighting cap.

In some implementations, the marking indicator can be a lighting cap, the lighting cap being tightly fitted with the base so as to prohibit water from entering an interior of the marking device when in the seated position. In some implementations, the lighting cap includes a solar panel electrically coupled to at least one LED bulb. In some implementations, the lighting cap is fixedly attached to the top portion of the uppermost leg of the at least two telescoping legs. In some implementations, the lighting cap is removably attached to the top portion of the uppermost leg of the at least two telescoping legs. In some implementations, the lighting cap includes a switch electrically coupled to a bulb held within the lighting cap. In some implementations, the switch controls an on/off function of a color change for the bulb.

### BRIEF DESCRIPTION OF THE DRAWINGS

FIG. 1 is a perspective view of a first implementation of a telescoping marking device of the disclosed technology;

FIG. 2 is a front view of the first implementation of the telescoping marking device of the disclosed technology;

FIG. 3 is a cross-sectional view of the first implementation of the telescoping marking device of the disclosed technology in a telescoped position;

FIG. 4 is a cross-sectional view of the first implementation of the telescoping marking device of the disclosed technology in a retracted position;

FIG. 5 is a partial view of the first implementation of the telescoping marking device of the disclosed technology;

FIG. 6 is a perspective view of a second implementation of the telescoping marking device of the disclosed technology;

FIG. 7 is a front view of the second implementation of the telescoping marking device of the disclosed technology;

FIG. 8 is a cross-sectional view of the second implementation of the telescoping marking device of the disclosed technology in a telescoped position;

FIG. 9 is a cross-sectional view of the second implementation of the telescoping marking device of the disclosed technology in a retracted position;

FIG. 10 is a partial view of the second implementation of the telescoping marking device of the disclosed technology;

FIG. 11 is a partial view of the second implementation of the telescoping marking device of the disclosed technology;

FIG. 12 is a close-up, partial view of the second implementation of the telescoping marking device of the disclosed technology;

FIG. 13 is a front view of the second implementation of the telescoping marking device of the disclosed technology in a retracted position seated within a ground surface;

FIG. 14 is a perspective view of a third implementation of the telescoping marking device of the disclosed technology;

FIG. 15 is a close-up, partial view of the third implementation of the telescoping marking device of the disclosed technology;

FIG. 16 is a close-up, partial view of the fourth implementation of the telescoping marking device of the disclosed technology;

FIG. 17 is a perspective view of the fourth implementation of the telescoping marking device of the disclosed technology in a retracted position;

FIG. 18 is a perspective view of the fourth implementation of the telescoping marking device of the disclosed technology in a first position;

FIG. 19 is a perspective view of the fourth implementation of the telescoping marking device of the disclosed technology in a second position;

FIG. 20 is a perspective view of the fourth implementation of the telescoping marking device of the disclosed technology in a third position;

FIG. 21 is a close-up, partial view of the fifth implementation of the telescoping marking device of the disclosed technology;

FIG. 22 is a close-up, partial view of the sixth implementation of the telescoping marking device of the disclosed technology;

FIG. 23 is a perspective view of a seventh implementation of the telescoping marking device of the disclosed technology;

FIG. 24 is a close-up, partial view of the seventh implementation of the telescoping marking device of the disclosed technology;

FIG. 25 is a close-up, partial view of the seventh implementation of the telescoping marking device of the disclosed technology;

FIG. 26 is a perspective view of a eighth implementation of the telescoping marking device of the disclosed technology; and

FIG. 27 is a close-up, partial view of the seventh implementation of the telescoping marking device of the disclosed technology.

### DETAILED DESCRIPTION

The disclosed technology relates to a telescoping marking device. Specifically the telescoping marking device is designed so that it can be seated within a ground surface in a retracted position and telescoped up, in multiple positions, when in an extended position, as will be described more fully below.

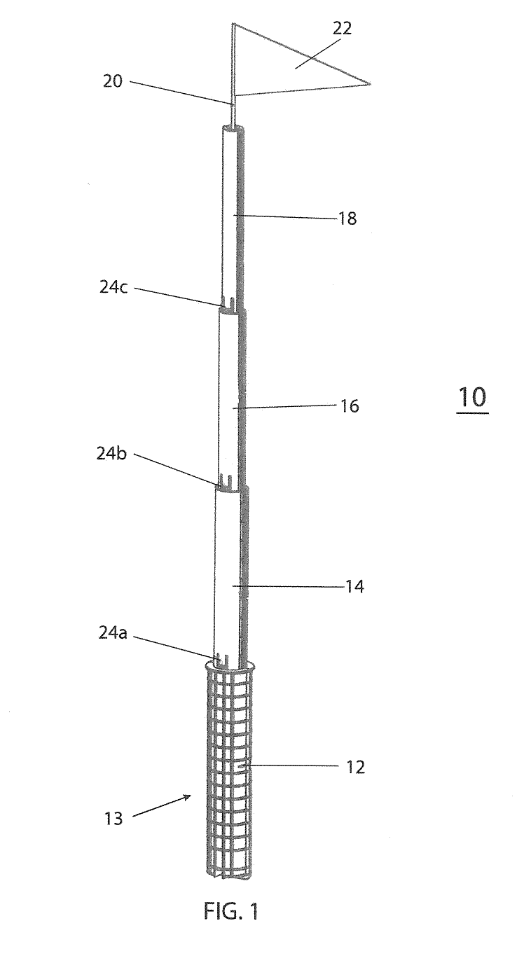

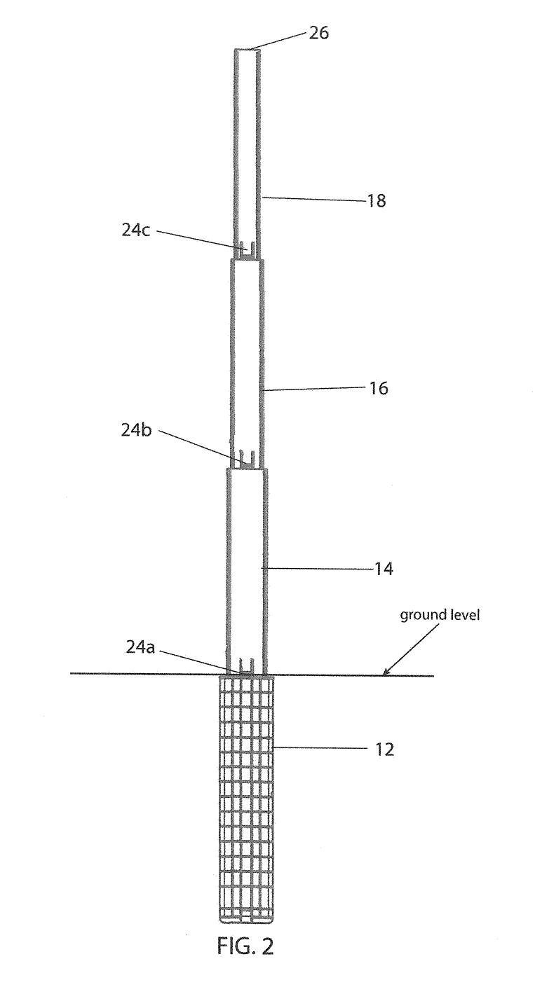

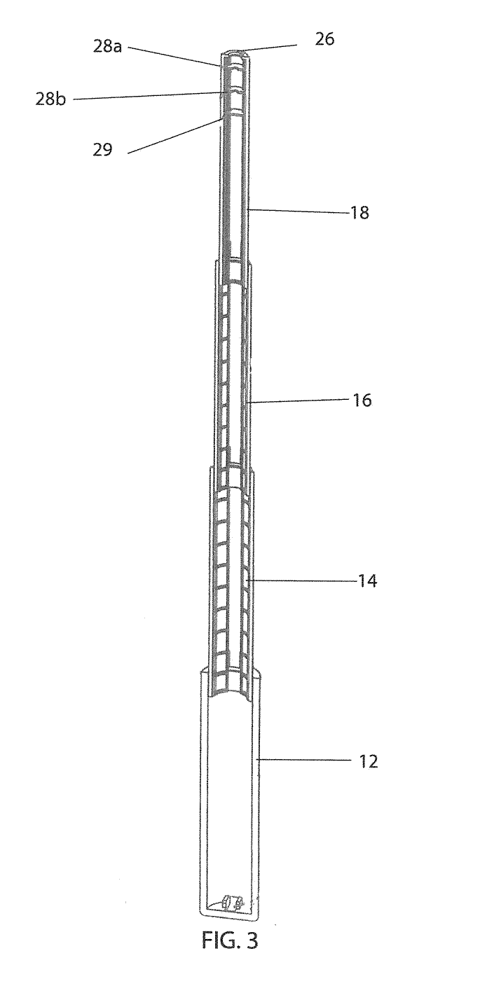

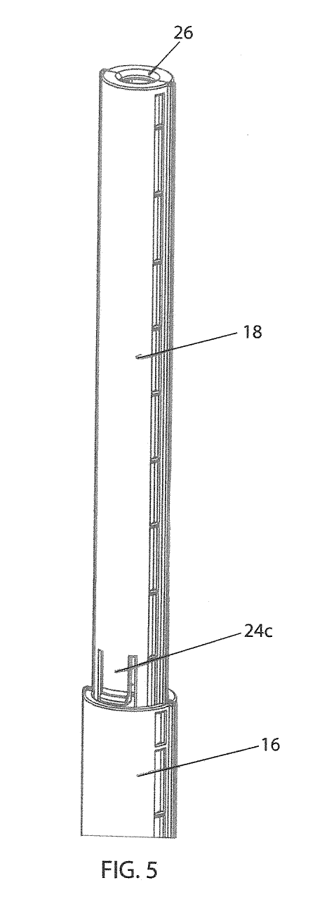

As shown in FIGS. 1-5, a first implementation of a telescoping marking device 10 can include a base 12, a first section 14, a second section 16 and a third section 18, however, in other implementations one more sections can be utilized.

The base 12 can include a ribbed outer layer 13 for allowing the base 12 to buried and seated beneath a surface of the ground. The ribbed section layer 13 allows the base 12 to have an increased surface area on its exterior so that the base 12 can be firmly planted with the ground, however, other grounding and fixing techniques are contemplated.

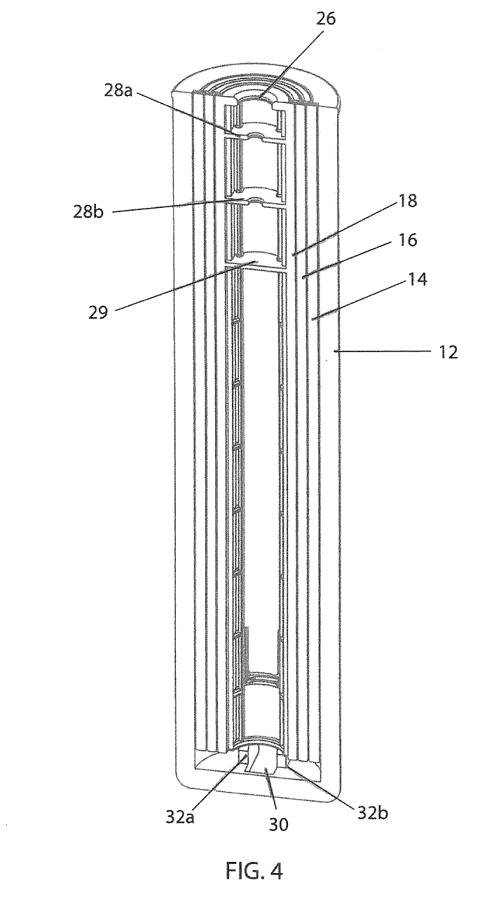

The base 12 can be movably coupled to the first section 12, second section 14 and third section 16 in a telescoping manner. The first section 12, second section 14 and third section 16 can include locking mechanisms 24a-c for locking the sections 12, 14, 16 in an extended position. That is, the telescoping marking device 10 can be extended from a retracted position, as shown in FIG. 4, into an extended position, as shown in FIGS. 1-3, and locked in the telescoped position through the use of locking tabs 24a-c. These tabs 24a-c can be under a compression force and automatically lock when the marking device 10 is moved from the retracted position to the telescoped position. These tabs 24a-c can be released by applying pressure to the tabs 24a-c thereby releasing the first section 12, the second section 14 and the third section 16 from engagement with each other and allow the marking device 10 to return to its retracted position.

As shown in FIG. 4, in a retracted position, the first section 14, the second section 16 and third section 18 can be retracted within the base 12. In order to telescope the marking device 10, the third section 18 can include an opening 26 at its top. This opening 26 allows a user to place a finger or an operating device within the opening 26 so the user can pull the first section 14, the second section 16 and the third section 18 out of the base 12 and lock the first section 14, the second section 16 and the third section 18 in the telescoped position.

The third section 18 (being the uppermost section when in the extended position) can also include flag post openings 28a-b and a flag rest platform 29 within a top hollow portion of the third section 18. The flag post openings 28a-b allows the third section 18 to receive and secure a post 20 of a marking flag 22.

The bottom of the base 12 can further include a drain hole 30 and elevation steps 32a-b. The elevation steps 32a-b allow the first section 14, second section 16 and third section 18 to sit slightly above the drain hole of the base 12 when in a retracted position as shown in FIG. 4. The drain hole 30 allows any water that enters the marking device to drain into the ground. In some implementations, a cap (not shown) can be utilized to cover opening 26 when the marking device is a retracted position so that water is inhibited from entering the hollow section of the marking device 10.

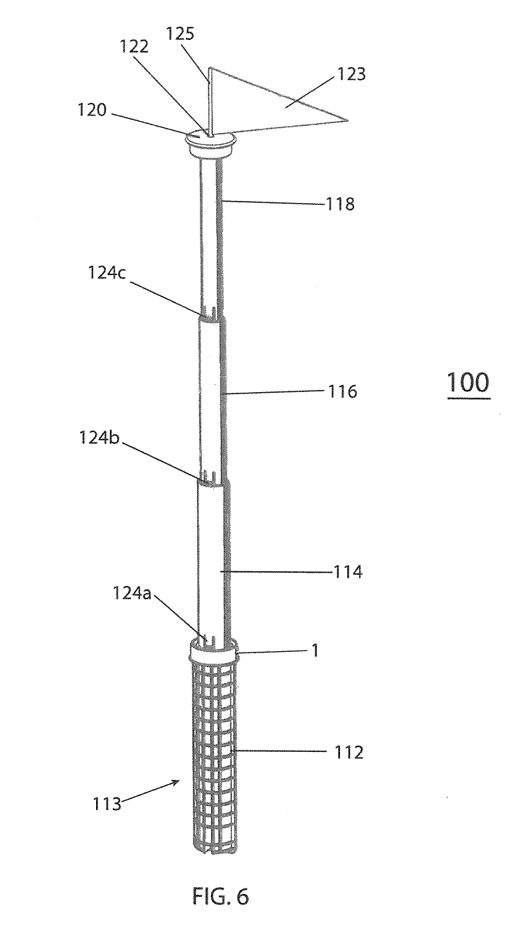

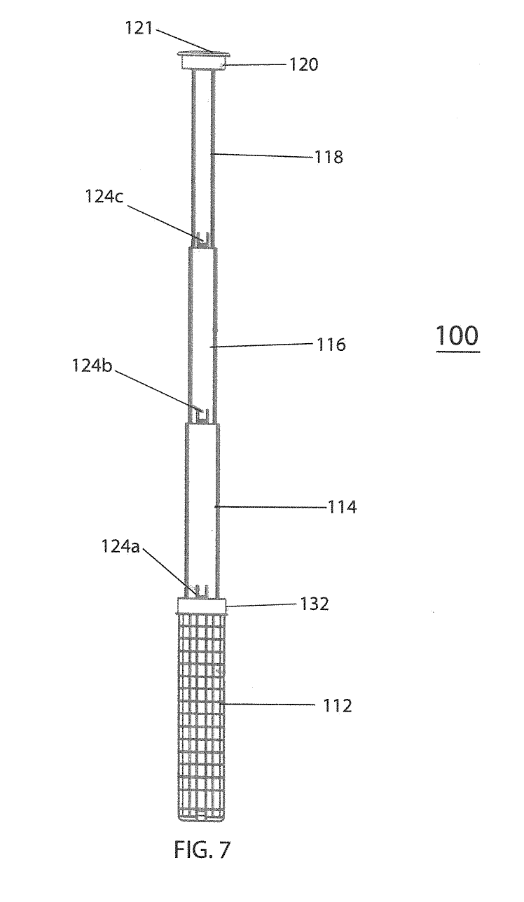

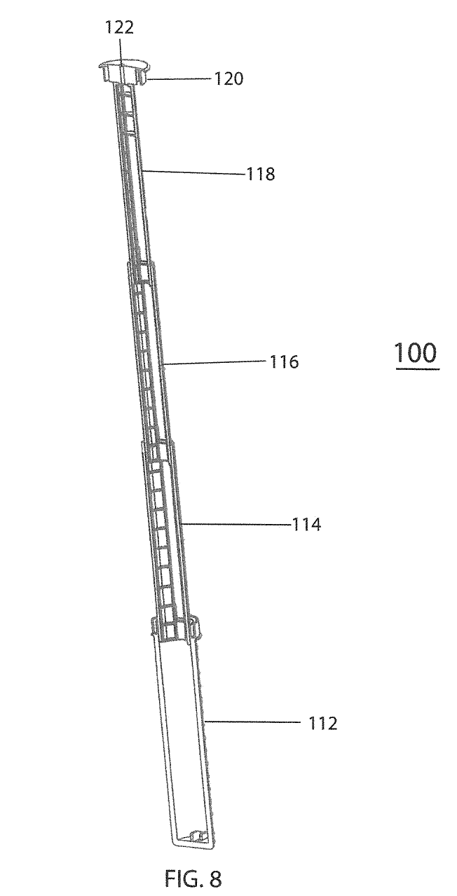

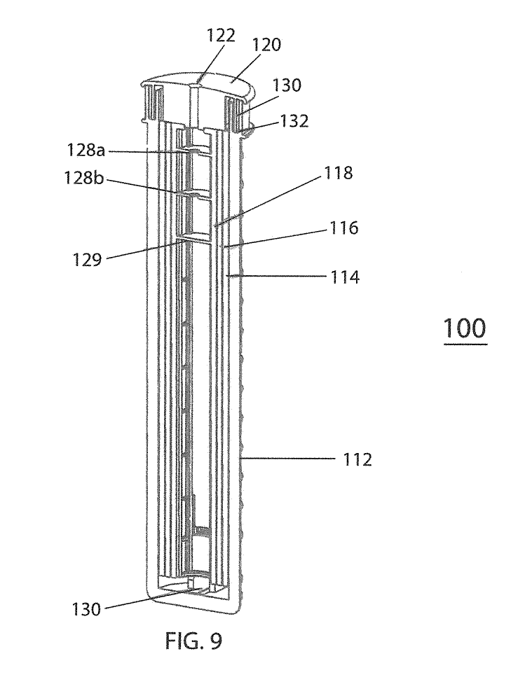

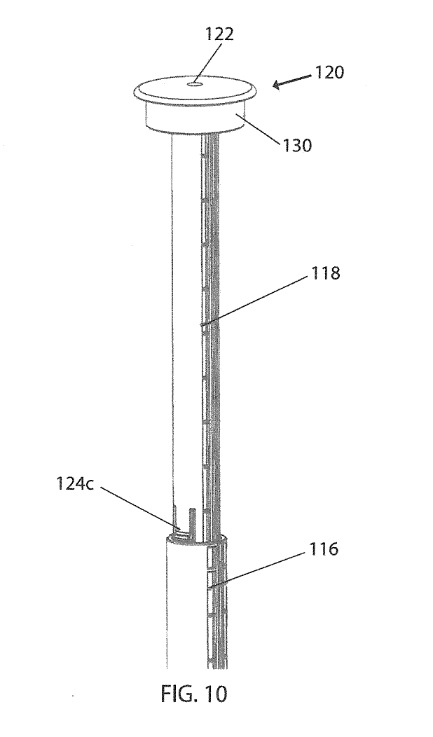

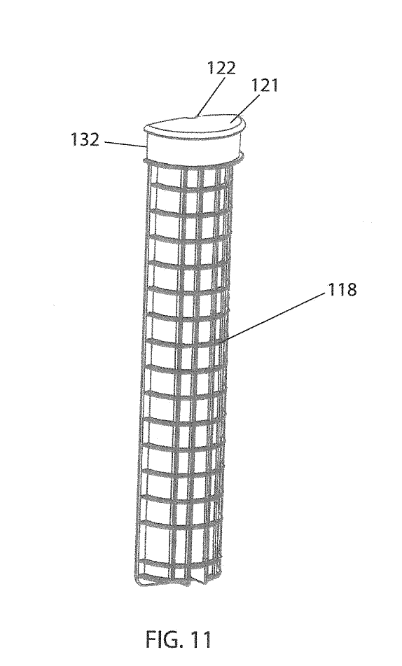

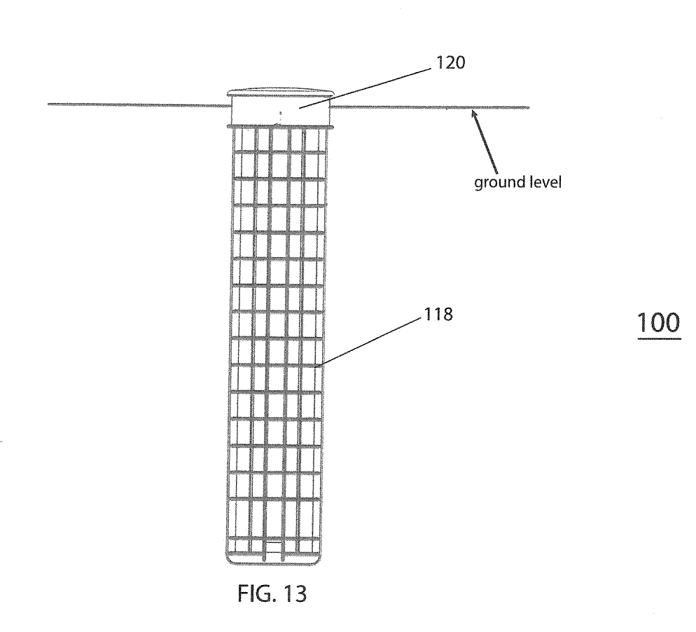

As shown in FIGS. 6-13, a second implementation of a telescoping marking device 100 can include a base 112, a first section 114, a second section 116, a third section 118 and cap 120.

The cap 120 can fixedly or removably attached to the third section 118. The cap 120 can include an outer edge 130, a top surface 121 and an opening 122. In some implementations, an edge of the top surface 121 of the cap 120 can be curved so that water does not collect on its surface. In some implementations, the opening 122 can be capable of receiving a post 125 of a marking flag 123. The first section 118 can also include flag retainers 128a-b and a flag rest platform 129 for securing the flag post 125. In some implementations, a plug (not shown) can be utilized to close the opening 122 when the marking device is a retracted position so that water is inhibited from entering the hollow section of the marking device 10.

The base 112 can include a cap receiving section 132 and a ribbed outer layer 113. The ribbed outer layer 113 allows the base 112 to be buried within a fixing structure, e.g., a ground surface. The bottom of the base 112 can include a drain hole 130 for draining water that enters the inner portion of the marking device 100 and elevation steps 132a-b to allow the first section 114, second section 116 and third section 118 to sit slightly above the drain hole of the base 12 when in a retracted position.

The first section 114, second section 116 and third section 118 can include locking mechanisms 124a-c for locking the sections 114, 116, 118 in a telescoped position, as discussed above with respect to the first implementation.

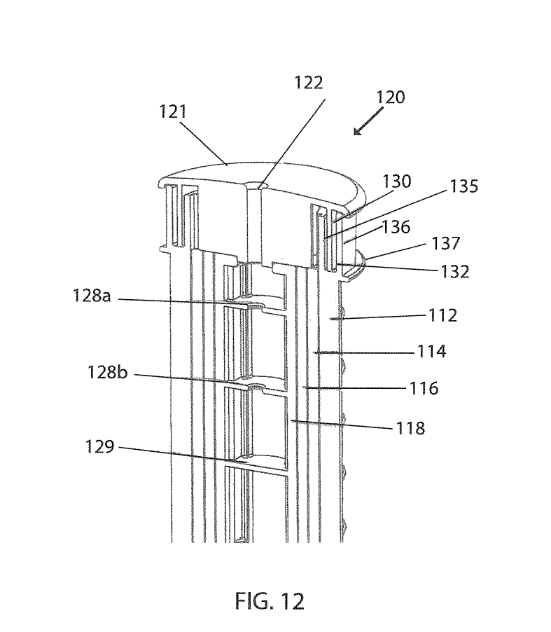

In a closed position, the first section 114, second section 116 and third section 118 can be retracted within the base 112. In order to prevent water from entering the retracted marking device 10, the cap 120 and the cap receiving section 132 of the base can be brought together in such a way as to seal an interior of the marking device 100. As shown in FIG. 12, the cap receiving section 132 of the base 112 can include an outer wall 136, an inner wall 135 and a lip 137. The area between the outer wall 136 and the inner wall 135 allows the outer edge 130 of the cap 120 to sit within the area of the outer wall 136 and the inner wall 135 when in a retracted position. The top surface 121 of the cap 120 can also extend over the outer wall 136 so that any water that falls off the top surface falls to the ground surface and does not enter the interior of the marking device 100. This arrangement allows the cap 120 to be tightly fitted with the base 112 so as to prohibit water from entering the inner portion of the marking device 100 when in a retracted position. This is helpful during winter months when any water retained in the marking device could potentially freeze and make the telescoping operation of the marking device inoperable.

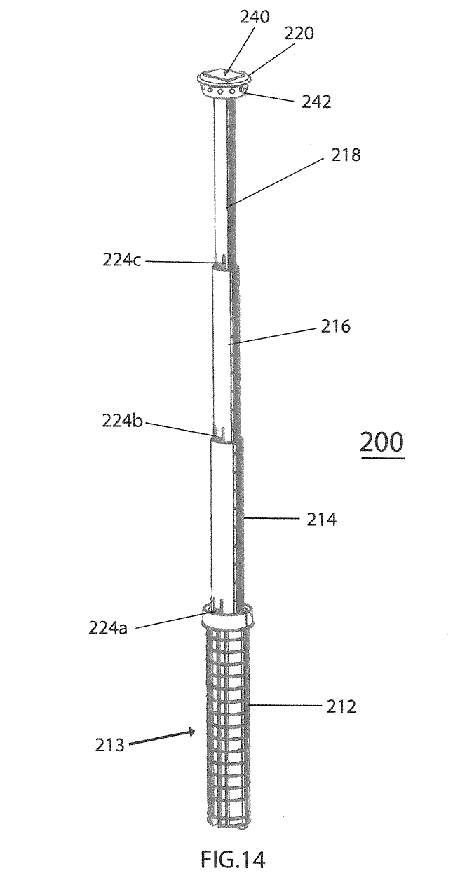

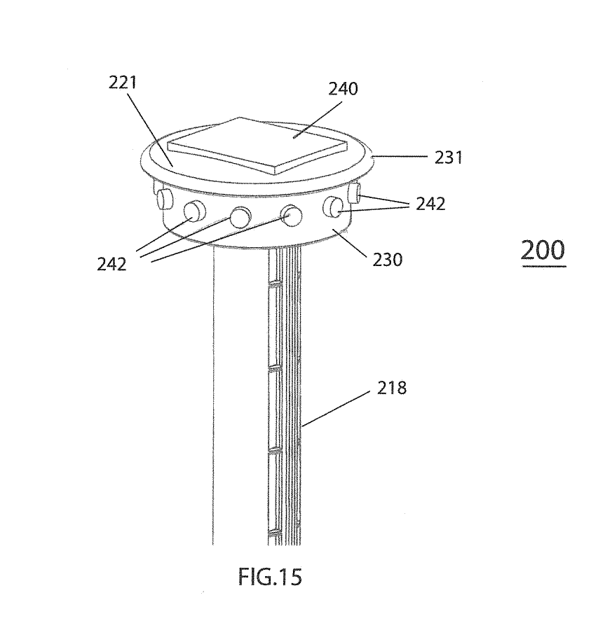

As shown in FIGS. 14-15, a third implementation of a telescoping marking device 200 can include a base 212, a first section 214, a second section 216, a third section 218 and cap 220.

The cap 220 can fixedly or removably attached to the third section 218. The cap 220 can include an outer edge 230, a top surface 221 with a curved circumference 231, a solar panel 240 and one or more LED lights 242, however, other types of lighting systems are contemplated. In some implementations, the solar panel can be electrically connected to the LEDs so that the LEDs can be lite and used as a marking to any person approaching the marking device 200. In some implementations, the top surface 221 of the cap 220 can be curved so that water does not collect on its surface.

The base 212 can include a cap receiving section 232 and a ribbed outer layer 213. The ribbed outer layer 213 allows the base 112 to be buried within a fixing structure, e.g., a ground surface.

The first section 214, second section 216 and third section 218 can include locking mechanisms 224a-c for locking the sections 214, 216, 218 in a telescoped position, as discussed above with respect to the first implementation.

In a closed position, the first section 214, second section 216 and third section 218 can be retracted within the base 212. In order to prevent water from entering the retracted marking device 200, the cap 220 and the cap receiving section 232 of the base can be brought together in such a way as to seal an interior of the marking device 200, as discussed above in the second implementation. This arrangement allows the cap 220 to be tightly fitted with the base 212 so as to prohibit water from entering the inner portion of the marking device 200 when in a retracted position. This is helpful during winter months when any water retained in the marking device could potentially freeze and make the telescoping operation of the marking device inoperable.

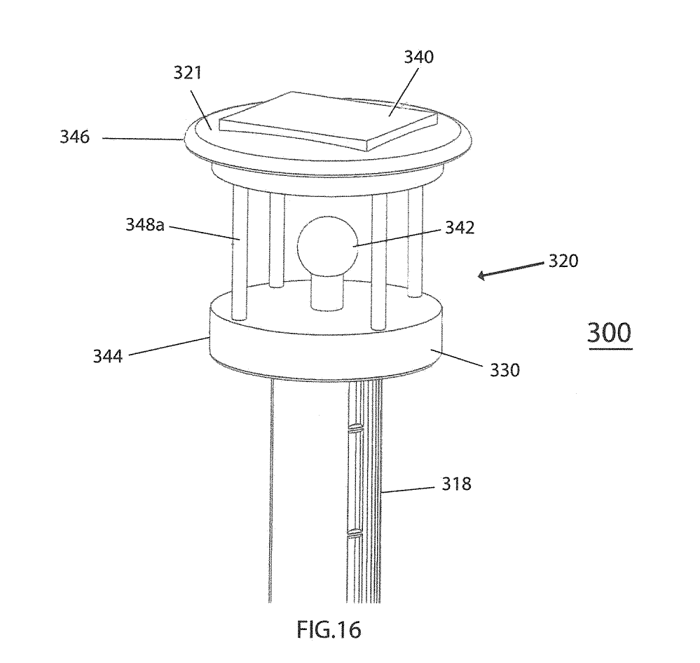

As shown in FIGS. 16-20, a fourth implementation of a telescoping marking device 300 can include a base 312, a first section 314, a second section 316, a third section 318 and a lighting cap 320.

The lighting cap 320 can fixedly or removably attached to the third portion 318. The cap 320 can include an outer edge 330, a top surface 321, a bottom surface 344, posts 348a-d, a solar panel 340 and one or more LED lights 342, however, other types of lighting systems are contemplated. In some implementations, the solar panel 340 can be electrically connected to the LED 342 so that the LED can be lite and used as a marking to any person approaching the marking device 300. In some implementations, the top surface 321 of the cap 320 can be curved so that water does not collect on its surface.

The base 312 can include a cap receiving section 332 and a ribbed outer layer 313. The ribbed outer layer 313 allows the base 312 to be buried within a fixing structure, e.g., a ground surface.

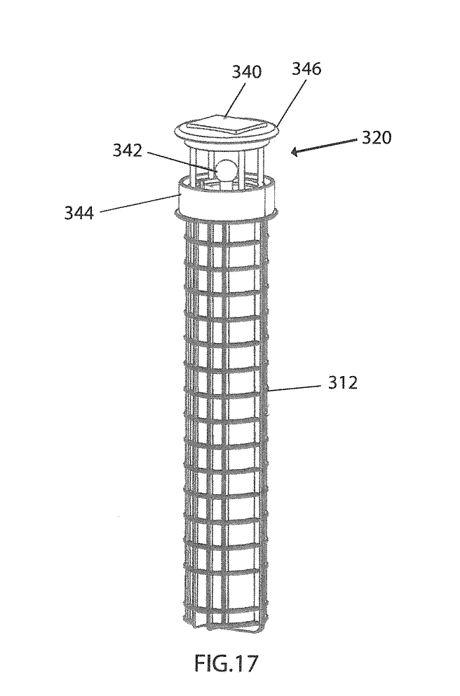

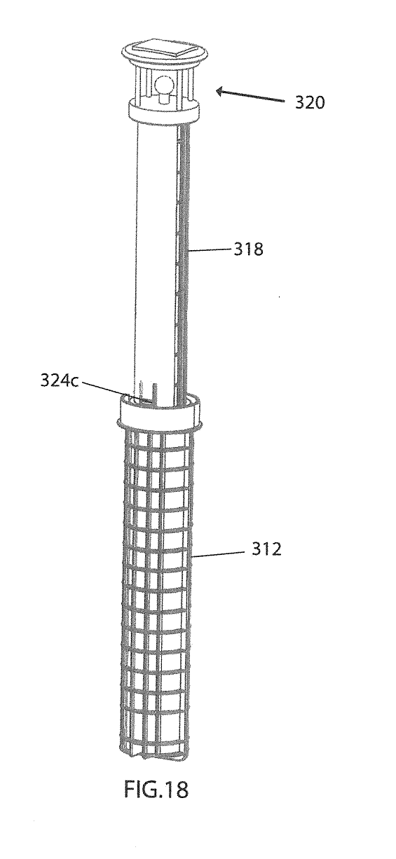

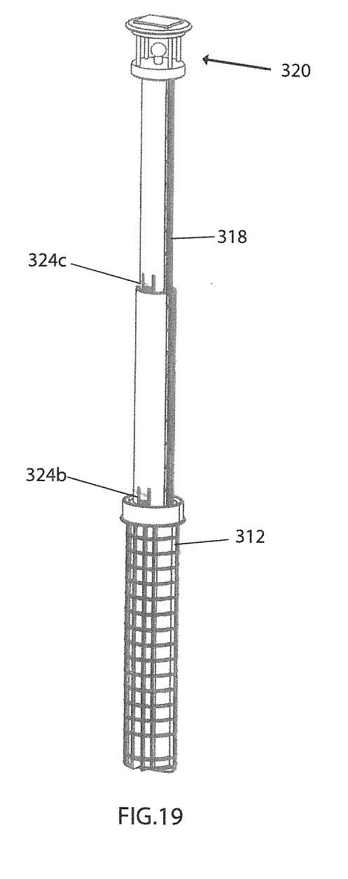

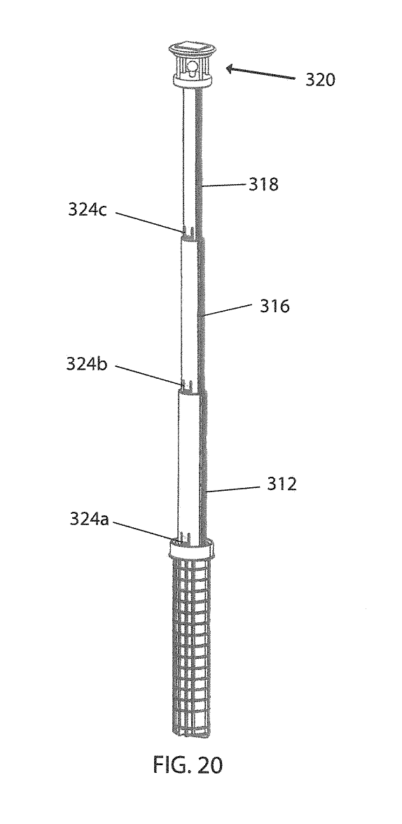

The first section 314, second section 316 and third section 318 can include locking mechanisms 324a-c for locking the marking device 400 in four telescoped positions—(1) in a first position, the first, second and third sections 214, 316, 318 are retracted with the base 312 (FIG. 17), (2) in a second position, the third section is visible (FIG. 18), (3) in a third position, the second and third sections are visible (FIG. 19) and (4) in a fourth position, the first second and third sections are visible (FIG. 20).

In order to prevent water from entering the retracted marking device 300, the lighting cap 320 and a cap receiving section 332 of the base 312 can be brought together in such a way as to seal an interior of the marking device 300, as discussed above in the second implementation. This arrangement allows the lighting cap 320 to be tightly fitted with the base 312 so as to prohibit water from entering the inner portion of the marking device 300 when in a retracted position. This is helpful during winter months when any water retained in the marking device could potentially freeze and make the telescoping operation of the marking device inoperable.

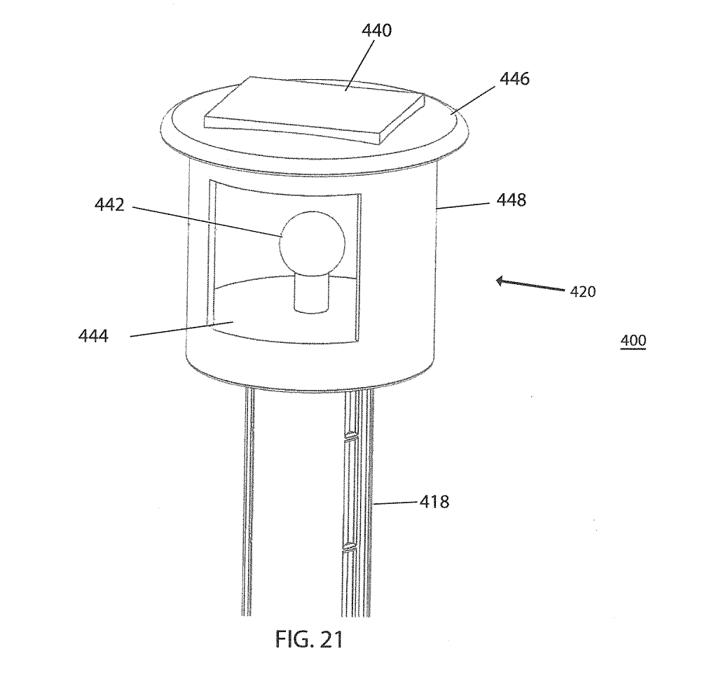

As shown in FIG. 21, a fifth implementation of a telescoping marking device 400 can include a lighting cap 420.

The lighting cap 420 can include an upper platform 446 and a lower platform 444 and shroud 448. The lighting cap 420 can further include a solar panel 440 electrically coupled to a single LED bulb 448 but more bulbs in different configurations are contemplated. The lighting cap 420 and can be fixedly attached to a top portion of the first section 418.

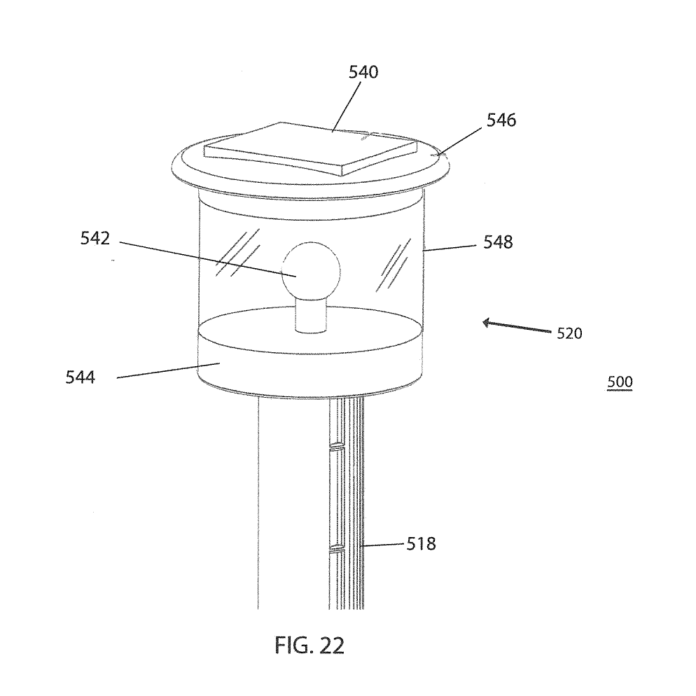

As shown in FIG. 22, a sixth implementation of a telescoping marking device 500 can include a lighting cap 520.

The lighting cap 520 can include an upper platform 546 and a lower platform 544 and shroud 548. The lighting cap 520 can further include a solar panel 540 electrically coupled to a single LED bulb 542 but more bulbs in different configurations are contemplated. The lighting cap 520 and can be fixedly attached to a top portion of the first section 518.

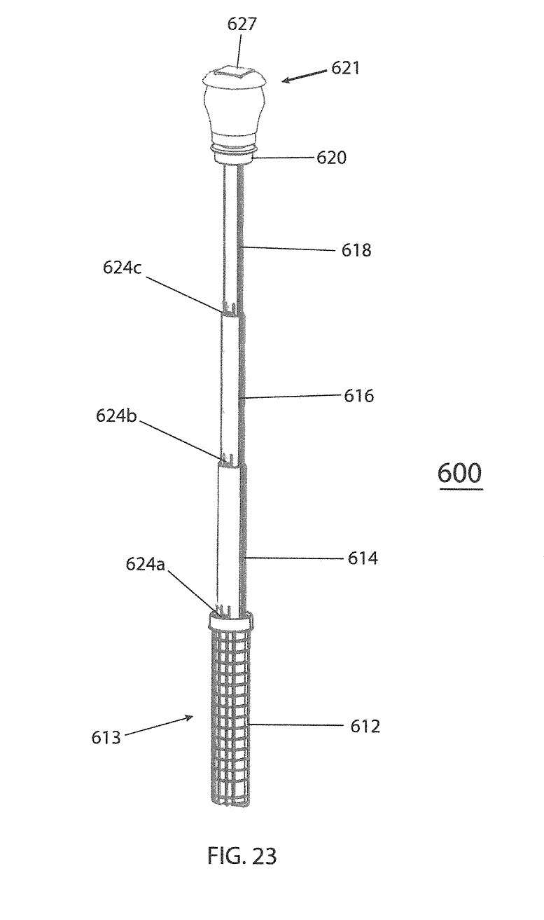

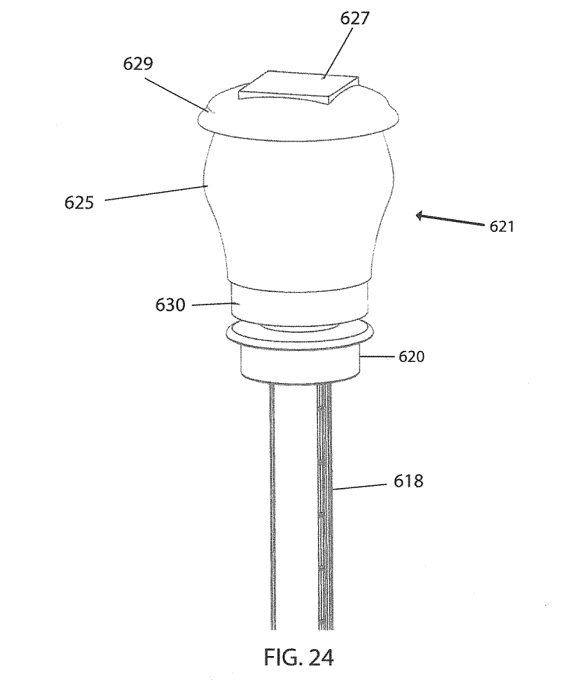

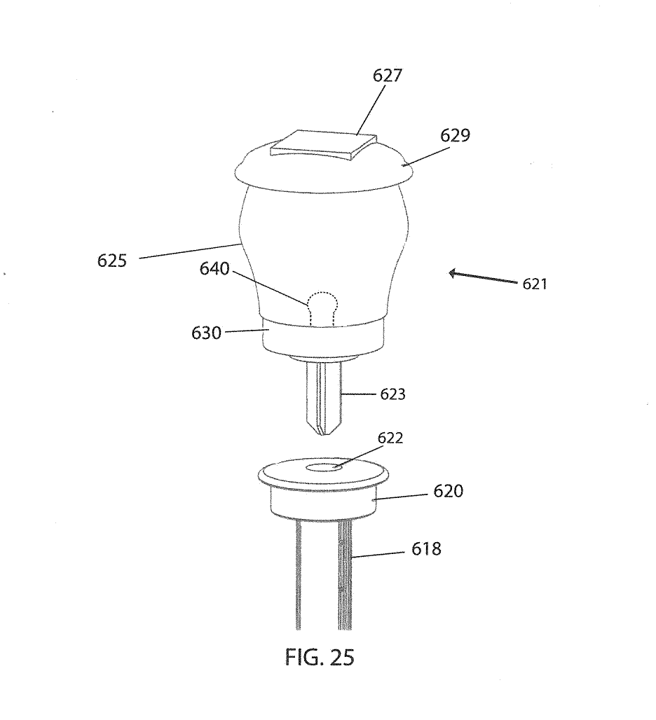

As shown in FIGS. 23-25, a seventh implementation of a telescoping marking device 600 can include a base 612, a first section 614, a second section 616, a third section 618, a cap 620 and a lighting fixture 621.

The cap 620 can fixedly or removably attached to the third section 618. The cap 620 can include an outer edge 620, a top surface 623 and an opening 622. In some implementations, an edge of the top surface 623 of the cap 620 can be curved so that water does not collect on its surface. In some implementations, the opening 622 can be capable of receiving a lighting fixture 621.

The base 612 can include a cap receiving section 632 and a ribbed outer layer 613. The ribbed outer layer 613 allows the base 612 to be buried within a fixing structure, e.g., a ground surface.

The first section 614, second section 616 and third section 618 can include locking mechanisms 624a-c for locking the sections 614, 616, 618 in a telescoped position, as discussed above with respect to the first implementation.

The lighting fixture 621 can include an upper platform 629, a lower platform 630, shroud 625 and spike 623. The lighting fixture 621 can further include a solar panel electrically coupled to a single LED bulb 640 but more bulbs in different configurations are contemplated. The lighting fixture 621 can be removably attached to the cap 620 by inserting the spike 623 into opening 622.

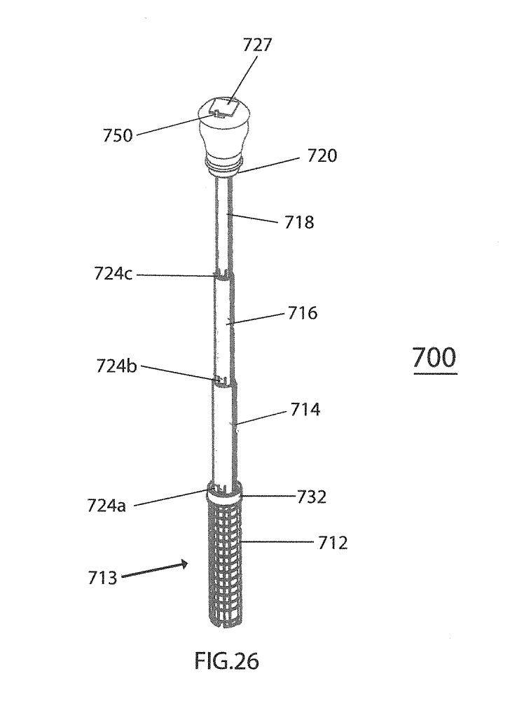

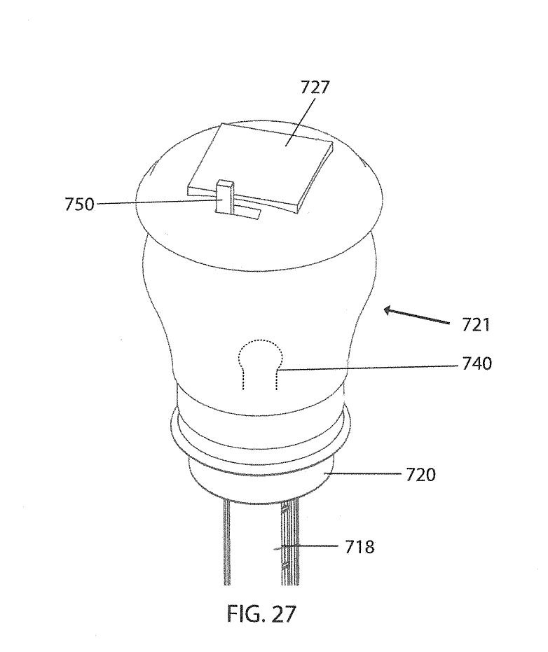

As shown in FIGS. 26-27, an eighth implementation of a telescoping marking device 700 can include a base 712, a first section 714, a second section 716, a third section 718, a cap 720 and a lighting fixture 721.

The cap 720 can fixedly or removably attached to the third section 718. The lighting fixture 721 can include a solar panel electrically coupled to an LED bulb(s) 740 but more bulbs in different configurations are contemplated. The LED bulb(s) 740 can be an RGB LED bulb that is capable of color change. The lighting fixture 721 can further include switch 750 for turning the LED bulb on/off and/or changing a color of the RGB LED bulb.

The base 712 can include a cap receiving section 732 and a ribbed outer layer 713. The ribbed outer layer 713 allows the base 712 to be buried within a fixing structure, e.g., a around surface.

The first section 714, second section 716 and third section 718 can include locking mechanisms 724a-c for locking the sections 714,716, 718 in a telescoped position, as discussed above with respect to the first implementation.

While presently preferred embodiments have been described for purposes of the disclosure, numerous changes in the arrangement can be made by those skilled in the art. Such changes are encompassed within the spirit of the invention as defined by the appended claims.

The foregoing Detailed Description is to be understood as being in every respect illustrative and exemplary, but not restrictive, and the scope of the disclosed technology disclosed herein is not to be determined from the Detailed Description, but rather from the claims as interpreted according to the full breadth permitted by the patent laws. It is to be understood that the embodiments shown and described herein are only illustrative of the principles of the disclosed technology and that various modifications may be implemented by those skilled in the art without departing from the scope and spirit of the disclosed technology. Those skilled in the art could implement various other feature combinations without departing from the scope and spirit of the disclosed technology. Although the embodiments of the present disclosure have been described with specific examples, it is to be understood that the disclosure is not limited to those specific examples and that various other changes, combinations and modifications will be apparent to one of ordinary skill in the art without departing from the scope and spirit of the disclosed technology which is to be determined with reference to the following claims.

1. A marking device comprising:
a base;
at least two telescoping legs movably coupled to the base; and
an indicator, the indicator being attached to a top portion of an uppermost leg of the at least two telescoping legs, the marking device including: (1) a retracted position wherein the at least two telescoping legs are seated within the base and (2) an extended position wherein the at least two telescoping legs are telescoped outwards from the base and locked in the extended position.

2. The marking device of claim 1 wherein the base includes a ribbed outer layer, the ribbed outer layer capable of being seated beneath a ground surface.

3. The marking device of claim 2 wherein the base includes a drain hole and elevation steps.

4. The marking device of claim 3 wherein the elevation steps allow the at least two telescoping legs to sit above the drain hole when in the retracted position.

5. The marking device of claim 1 wherein the at least two telescoping legs include a first section, a second section and a third section.

6. The marking device of claim 5 wherein the first section, the second section and the third section include locking mechanisms for locking the first section, the second section and the third section in the extended position.

7. The marking device of claim 1 further comprising:
a cap, the cap covering a top portion of the marking device so that water is inhibited from entering an interior of the marking device.

8. The marking device of claim 7 wherein the cap includes an opening for receiving the indicator.

9. The marking device of claim 8 wherein the indicator is a flag.

10. The marking device of claim 8 wherein the indicator is a lighting fixture.

11. The marking device of claim 10 wherein the lighting fixture includes a spike for attaching to the cap via the opening.

12. The marking device of claim 10 wherein the lighting fixture includes a solar panel electrically coupled to at least one LED bulb.

13. The marking device of claim 12 wherein the lighting fixture includes a shroud.

14. The marking device of claim 12 wherein the lighting fixture includes a switch electrically coupled to the at least one LED bulb.

15. The marking device of claim 1 wherein the indicator is a lighting cap, the lighting cap being tightly fitted with the base so as to prevent water from entering an interior of the marking device when in the retracted position.

16. The marking device of claim 15 wherein the lighting cap includes a solar panel electrically coupled to at least one LED bulb.

17. The marking device of claim 15 wherein the lighting cap is fixedly attached to the top portion of the uppermost leg of the at least two telescoping legs.

18. The marking device of claim 15 wherein the lighting cap is removably attached to the top portion of the uppermost leg of the at least two telescoping legs.

19. The marking device of claim 16 wherein the lighting cap includes a switch electrically coupled to the at least one LED bulb held within the lighting cap.

20. The marking device of claim 19 wherein the switch controls an on/off function or a color change for the at least one LED bulb.
